(19) United States
(12) Patent Application Publication
(10) Pub. No.: US 2012/0226510 A1
(43) Pub. Date: Sep. 6, 2012

(54) SYSTEM AND METHOD FOR PROVIDING PROJECT STATUS METRICS

(75) Inventors: Pushkala VENKATESWARAM, Hyderabad (IN); Venkateswaran Venkatasubramanian, Hyderabad (IN); Vikas Bansal, Cupertino, CA (US); Vikram Takru, Cupertino, CA (US)

(73) Assignee: Enterprise Signal Inc., Cupertino, CA (US)

(21) Appl. No.: 13/039,333

(22) Filed: Mar. 3, 2011

(51) Int. Cl. G06Q 10/00

(52) U.S. Cl. 705/7.11

(57) ABSTRACT

A method, a system and a computer program product for providing status metric of a project to a user is a provided. An input data corresponding to the project may be received from a service provider. Further, the input data may be validated based on one or more pre-defined rules. The validated data may be aggregated into one or more tables. One or more attributes of the aggregated data, from the one or more tables, may be analyzed to generate one or more reports. The generated report includes project information corresponding to the project. Further, the generated reports may be provided to the user. Thereby, the method provides the status metric of the project to the user.

### FIELD OF INVENTION

The present disclosure relates to the field of project management system, and more particularly to providing status metrics of a project to a user.

### BACKGROUND

Each project involves a plurality of tasks, subtasks, phases and resources for its completion. Generally, customers want to have insight into performance and status of their projects that they give, as tasks to be completed, to companies such as vendors or other service providers. Accordingly, the companies, such as service providers, provide the projects' status information, to their clients.

Conventionally, the projects' status information is provided through weekly or monthly status reports of the projects. Typically, such reports are prepared, manually, in the form of documents or presentations and are periodically sent to the clients on weekly basis or monthly basis.

However, such conventional ways of reporting, corresponding to a project, can provide limited amount of project information to clients. Further, such ways refrain the clients from getting various operational and other information corresponding to the projects. For example, clients may not be able to keep track on resource utilization, project schedules, effort estimation and risks associated with the project. Further, due to this, clients may not get correct estimation of the project cost. Further, such conventional ways do not provide quality and support metrics of the project. Also, if clients suggest any change in the weekly or monthly report then this may require more rework on the projects.

There exist reporting systems for in-house reporting of the projects to managers and executives on a strategic or on a tactical basis. However, these systems are not customer oriented as these systems are tailored to be used for in-house purposes. For example, such systems do not provide any information to the customers regarding their projects' growth and status and consequently, the customers are not able to estimate the cost of their projects accurately and thus the customers, typically, find difficulty in understanding an estimation of each project that is provided by the service provider.

Hence there is a need for a method and a system for providing operational and analytical information of each project to each client.

### SUMMARY

Embodiments of the present disclosure mentioned herein describe a method and a system for providing status metric of a project to a user.

In one embodiment, the present disclosure provides a computer-implemented method for providing status metric of a project to a user, such as a customer. The method includes receiving an input data corresponding to the project. The method further includes validating the input data based on one or more pre-defined rules. Further, the method includes aggregating the validated data into one or more tables. Furthermore, the method generates one or more reports by analyzing one or more attributes of the aggregated data from the one or more tables. The generated report includes project information corresponding to the project. Further, the method provides the generated one or more reports to the user. Thereby, the method provides the status metric of the project to the user.

In another embodiment, the present disclosure provides an online system for providing a status metric of a project to a user. The system includes a data consuming module, an aggregation module, a report generation module and a status providing module. The data consuming module receives an input data corresponding to the project. The data validating module is configured for validating the input data based on one or more pre-defined rules. Further, the aggregation module is configured for aggregating the validated data into one or more tables. The report generation module is configured to generate one or more reports by analyzing one or more attributes of the aggregated data from the one or more tables. The generated report comprises project information corresponding to the project. Furthermore, the status providing module is configured to provide the generated one or more reports to the user. Thereby, the system provides the status metrics of the project to the user.

In yet another embodiment, the present disclosure provides a computer program product for use with a computer. The computer program product includes a non-transitory computer usable medium having a computer readable program code embodied therein for providing a status metrics of a project to a user. The computer readable program code, when executed, performs a method. The method includes receiving an input data corresponding to the project. Further, the computer program code validates the input data based on one or more pre-defined rules. Furthermore, the computer program code aggregates the validated data into one or more tables. The computer program code further generates one or more reports by analyzing one or more attributes of the aggregated data from the one or more tables. The generated report includes project information corresponding to the project. Further, the computer program code provides the generated one or more reports to the user. Thereby the computer program code provides the status metrics of the project to the user.

Here, the user is a customer. Advantageously, the project status metrics may enable the user to keep track on the project and to have historical data corresponding to the project such as weekly reports, ticket closure trends and the like. Further, this enables the user to analyze the performance and effort utilization for the project. Further, the project information may assist the user in estimating the cost of the project based on various factors such as quality of the project, effort utilization for the project and the like.

Further, the system may enable the user to receive the project information on personal mobile devices such as IPAD/IPhone/Blackberry etc. Further, the user may be enabled to analyze the project status in an offline mode that is in case when the user is not utilizing the Internet. The user may get the project information on personal mobile devices if the user is in offline mode.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF FIGURES

In the accompanying figures, similar reference numerals refer to identical or functionally similar elements. These reference numerals are used in the detailed description to illustrate various embodiments and to explain various aspects and advantages of the present disclosure.

FIG. 1 illustrates a block diagram of an environment to implement a system, in accordance with various embodiments of the disclosure;

FIG. 2 illustrates a block diagram of a system for providing status metrics of a project to a user, in accordance with an embodiment of the disclosure;

FIG. 3 illustrates a block diagram representing an exemplary implementation of a system for providing status metrics of a project to a user, in accordance with an embodiment of the disclosure.

FIG. 4 is a flowchart illustrating a method for providing status metrics of a project to a user, in accordance with an embodiment of the disclosure; and

FIG. 5 is an exemplary data model, in accordance with one embodiment of the disclosure.

The method has been represented where appropriate by conventional symbols in the drawings, showing only those specific details that are pertinent for understanding the embodiments of the present disclosure so as not to obscure the disclosure with details that will be readily apparent to those of ordinary skill in the art having the benefit of the description herein

### DETAILED DESCRIPTION

It may be observed that the components of the system and method steps have been represented by conventional symbols in the figure, showing only specific details which are relevant for an understanding of the present disclosure. Further details may be readily apparent to person ordinarily skilled in the art, and may not have been disclosed. In the present disclosure, relational terms, may be used to distinguish one entity from another entity, without necessarily implying any actual relationship or order between such entities.

Embodiments in the present disclosure as described herein provide a method, a system and a computer program product for providing status metrics of a project to a user. Here, user is a customer (client) of a company that provides services (hereinafter referred to as ‘service provider’ or ‘vendor’ interchangeably) corresponding to a project. The service provider may include, but is not limited to, a consulting company, an outsourcing company, and other service company. The project may be assigned to the service provider by the customer. The customer and the service provider may pre-define a unified service level agreement (SLA) to define services that will be provided by the service provider. Further, the SLA may define priorities, responsibilities, guarantees, project delivery time and performance corresponding to the project.

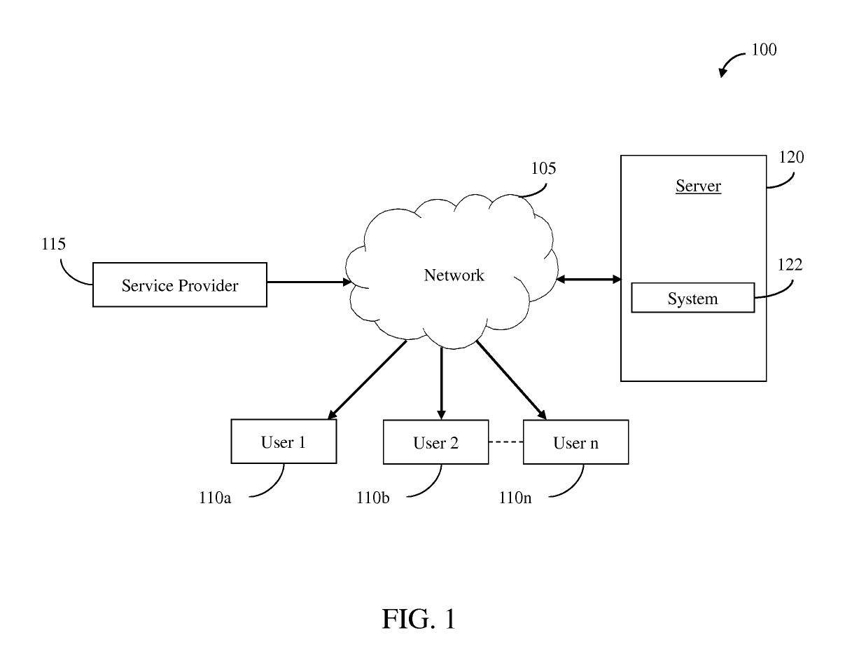

The system is an automated online tool that may enable the user to view status metrics of the project (hereinafter interchangeably referred to as ‘project status’). The status metrics may include, but is not limited to, information corresponding to the project (hereinafter interchangeably referred to as the ‘project information’) such as operational metrics, analytics, effort estimation, resource utilization, quality, time tracking of the project and the like. In an embodiment, the user (customer) may need to register with the system to keep track on the status of the project. In this embodiment, the user may provide login details to access the system. On accessing the system, the user may be provided with a Graphical user interface (GUI) to view the project's status information. The project status information may be uploaded, to the system, by the service provider. The project status information may provide real-time information corresponding to the project that may be carried out by the service provider. The system may be implemented in an environment as described in conjunction with FIG. 1.

FIG. 1 illustrates a block diagram of an environment 100, in accordance with various embodiments of the disclosure. The environment 100 includes a network 105, one or more users (customers) such as user 1 110a, user 2 110b . . . to user n 110n (hereinafter collectively referred to as “users 110”) a service provider 115, a server 120, and a system 122. The network 105 connects the users 110, the service provider 115, and the system 122 that may reside on the server 120.

The network 105 may include, but is not restricted to, a Local Area Network (LAN), a Wireless Local Area Network (WLAN), a Wide Area Network (WAN), Internet, and a Small Area Network (SAN). Each user, such as a user 110a, may be a customer of the service provider 115. The service provider 115 may include, but is not restricted to, a consulting company, an outsourcing company, and other service company. The server 120 may include a web server. Further, the system 122 may be uploaded to the server 120 to perform an application of providing status metrics of a project to the user. The system 122 may be uploaded by the service provider 115.

Each user may provide a request, through the network 105, to the service provider 115 for completing the project. The service provider 115 may provide the status of the project through the system 122 that may be accessed by each of the users 110. In an embodiment, the user may need to register with the system 122 to view the status of the project.

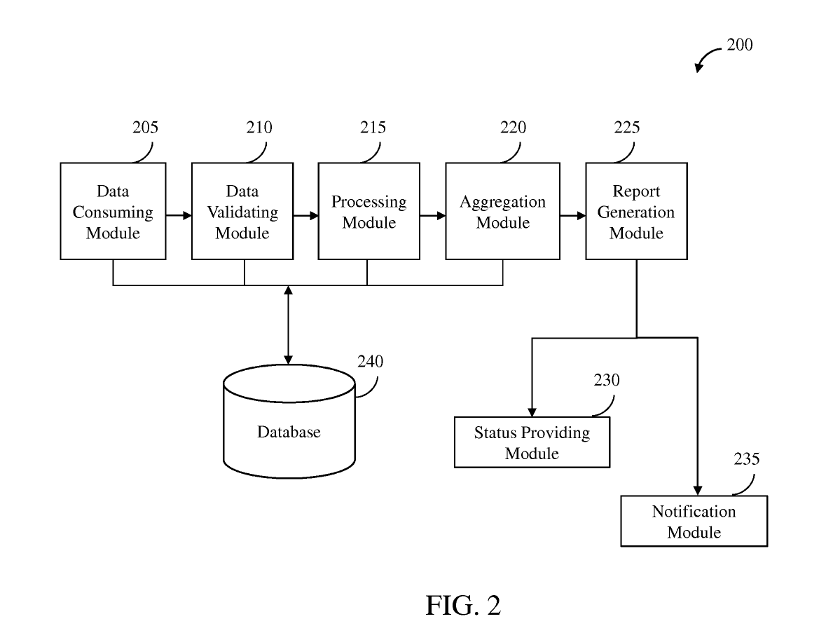

In an embodiment, the server may be utilized in cloud architecture. The system 122 may reside on the server 120 for providing utility to one or more users (clients) through the network 105. Each user may access the system 122 individually on their local systems at a time. The system 120 is explained further, in more details, in conjunction with FIG. 2.

FIG. 2 illustrates a block diagram of a system 200 for providing status metrics of a project to a user, in accordance with an embodiment of the disclosure. The project may be assigned by one or more users, such as users 110 (as shown in FIG. 1), to the service provider, such as the service provider 115 (as shown in FIG. 1). The service provider may include, but is not restricted to, a consulting company, an outsourcing company, and other service company. Each project may relate to a business area and may involve a plurality of tasks, subtasks, phases and resources, for its completion. Accordingly, the system 200 may be applied for various business areas.

In an embodiment, the system 200 is an online system that is accessible by a user through a network, such as Internet (as explained earlier in conjunction with FIG. 1). The system 200 includes a data consuming module 205, a data validating module 210 communicably coupled to the data consuming module 205, a processing module 215 communicably coupled to the data validating module 210, an aggregation module 220 communicably coupled to the processing module 215, a report generation module 225 communicably coupled to the aggregation module 220, status providing module 230, notification module 235, and a database 240. The status providing module 230 and the notification module 235 are communicably coupled to the report generation module 225.

In an embodiment, to utilize the system 200 for viewing the status metrics of a project, the user may be required to register with the system 200 to login into the system 200. After registering with the system 200, the user may be provided with a login screen (not shown) to enter login details therein. The login screen may be provided to the user for verifying the authenticity of the user. A successful login allows the user to enter into the system 200 to view the status metrics of the project. The status metrics may be uploaded to the system by the service provider (as explained below in this disclosure).

The data consuming module 205 may receive an input data corresponding to the project from the service provider. The input data may correspond to both operational information and other information correspond to the project that may be carried out by the service provider. The operational information may include, but is not limited to, weekly status report, project milestones, risks and issues, project iterations, goals and targets, action items, time estimation and resource requirement corresponding to the project. The other information may include, but is not restricted to, cost and revenue information such as invoices and the like for the project. The input data may be provided to the data validating module 210. Further, in an embodiment, the input data may be stored in the database 240.

The data validating module 210 may receive the input data from the data consuming module 205 to validate the input data. The input data may be validated (hereinafter referred to as ‘validated data’) to ensure that the input data has minimal or no error. Further, the input data may be validated based on a set of pre-defined rules. In one embodiment, the data validating module 210 may receive the input data from the database 240. The validated data may be provided to the processing module 215. In an embodiment, the validated data may be provided to the database 240.

The processing module 215 may process the validated data by performing one or more operations on the validated data. The processing module 215 may include, but is not limited to, an extract phase, a transformation phase and a load phase. In the extract phase, the processing module 215 may receive the information from the data validating module 210. In one embodiment, the processing module 215 may extract the validated data from the database 240. The database 240, containing the validated data, may be a relational database. Further, in an embodiment, the database may be a non-relational database such as Information Management System (IMS) or other data structures such as Virtual Storage Access Method (VSAM) or Indexed Sequential Access Method (ISAM).

Further, in extraction phase, the processing module 215 may convert the data into a suitable format. This suitable format may be provided to the transformation phase of the processing module 215. Further, in transformation phase, the processing module 215 may apply a set of rules and functions to the extracted data to derive a processed data. The rules and functions may be applied to meet operational needs of the system 200. Further, in the load phase, the processed data may be loaded in the database.

The aggregation module 220 may aggregate the data (hereinafter referred to as ‘aggregated data’) of the database into one or more table corresponding to facts and summary. The facts and summary may correspond to the status of the project. In one embodiment, the aggregation module may receive the validated data from the database 240 to aggregate the validated data into the one or more tables. Further, the aggregation module 220 may store the one or more tables in the database 240.

The report generation module 225 may read the data from the one or more tables of the aggregated data to generate one or more reports therefrom. The one or more reports may be generated by analyzing one or more attributes of the aggregated data of the one or more tables. Each report may include project information corresponding to the project. In an embodiment, the report may include daily information of the project that may represent the working status corresponding to the project. In an embodiment, the project information may include, but is not restricted to, project update, resource utilization information, effort estimation and quality information corresponding to the project. For example, if the service provider is in a phase of developing a project prototype then a report may represent the prototype information corresponding to the project. Further, for example if the client raises a ticket for either defects or enhancements or for providing support, all relevant information about the ticket may be tracked by the system 200 and may be represented in the report.

Further, in an embodiment, in case of cloud configuration, one or more web services may be designed that may be deployed on the cloud. In this embodiment, the report generation module may include a web service layer to read the data from the one or more tables of the aggregated data to assimilate the necessary attributes for report generation.

The generated reports may be provided to the status providing module 230. The status providing module 230 may provide the reports to a corresponding user. In an embodiment, the reports may be uploaded to the system to make them available for the user. The user may be able to view the reports on accessing the system 200 (as explained earlier in this disclosure). Further, in an embodiment for cloud configuration, the status providing module 230 may provide each report to the corresponding users of the system 200.

Further, each user may be facilitated to view reports with the last synced information corresponding to the project even in case the user is not connected to the network, such as the network 105 (as explained in conjunction with FIG. 1).

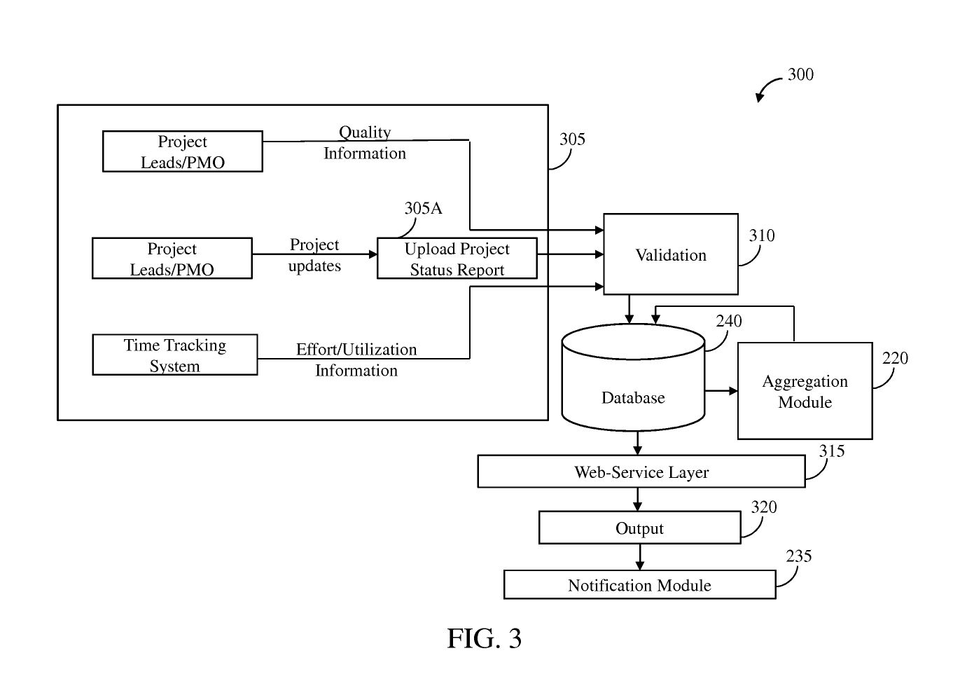

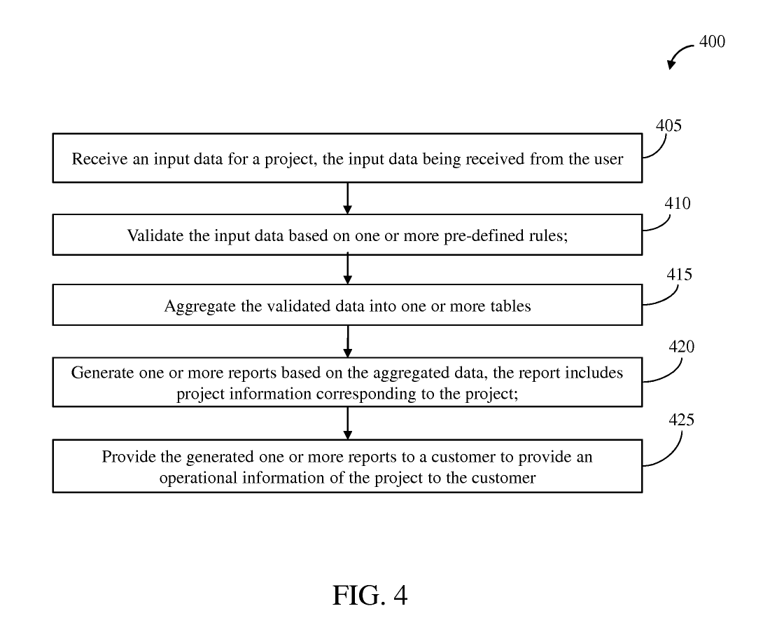

In an embodiment, the user may be of various types that may include, but are not limited to, consumers of native applications on Mobile Personal Devices, consumers of Web Application and consumers of other Business Intelligence System (BIS) that may leverage the aggregated data. In this, if the user is a consumer of native applications on Mobile Personal Device, the notification module 235 of the system 200 may provide notification, to the user, regarding the status of the project on his/her Mobile Personal Device such as a Mobile Phone. Further, for example, if the user is a consumer of Web Application, the user may be enabled to view the generated reports by accessing the system 200. The system 200 and functionality of each component of the system 200 may be understood more clearly when read in conjunction with description of FIG. 3 and FIG. 4.

FIG. 3 illustrates a block diagram representing an exemplary implementation of a system 300 for providing status metrics of a project to a user, in accordance with an embodiment of the disclosure. The user may include a customer that may assign the project to a service provider. Various blocks of the system 300 are already explained (in this disclosure) in conjunction with FIG. 1 and FIG. 2. Various blocks correspond to components as described in FIG. 2. The system 300 may provide visibility on project status metrics to customers, such as users 110 (as shown in FIG. 1). Here, the project status metrics may be defined as status metrics of the project that may include, but is not limited to, operational information and other information corresponding to the project. The operational information may be provided by providing one or more reports corresponding to project updates, quality information, effort utilization, resource utilization, ticketing information, project risk involvement and the like. The other information may include, but is not restricted to, cost and revenue information such as invoices and the like for the project.

The system 300 may include various blocks that may be understood in conjunction with FIG. 2. The system 300 includes a consuming block 305 (such as a data consuming module 205, as explained in FIG. 2) that may receive information corresponding to a project. The information may be received from a system user that deals with the project provided by a client user (hereinafter referred to as “customer”). The system user may include, but is not restricted to, an employee of a consulting company, a project execution team, or any other service provider company. Hereinafter the ‘system user’ may be referred to as ‘service provider’. The information may include, but is not limited to, project updates, quality information, and effort utilization information. In an embodiment, the information may be uploaded to the system 300 in form of various reports (as shown by a block 305A) to provide project status information to the customer.

The project updates (project information) may be uploaded to the system 300 by a Project Management Office (PMO) or a project handling team (such as a project lead) of the service provider company. The project updates may be provided to the customer (or uploaded to the system) on weekly basis to provide the status of building the project. For example, the service provider may upload one or more reports, to the system 300, for providing the project update to the customer. Further, the quality information may define a level of adherence of the service provider to a per-defined SLA. The SLA may include various standards, corresponding to building the project, set by both the service provider and the customer. In an embodiment, the project's quality may be achieved by adhering to the terms and standards of SLA. The quality information may be provided to the customer on-demand basis, i.e. if the customer demands.

Further, the effort utilization information may include information corresponding to time taken, man power and other resources that are utilized for the project. In an embodiment, the effort utilization information may be received from a time tracking system present at the service provider's end. The time tracking system may further be utilized by in-house team (of service provider) for billing the project. Further, in an embodiment, the effort utilization information may be provided to the customer on weekly basis.

Further, the service provider may provide ticketing information to the customer. The ticketing information may include support information corresponding to support work that is done (or required to be done) by one or more third parties to carry out one or more tasks corresponding to the project. The third party may include, but is not restricted to, a different department or a different team, such as technical support staff, of the service provider company and an outside vendor/company. For example, if a project related to a software industry may require a legal support work, a ticket may be raised, within or outside the service provider company, for legal support. Further, if the service provider company has a legal department, then a ticket may be raised to the legal department for the required support work. Further, in an example, if a service provider is a consulting company and, for a project received, the service provider requires a technical advancement for the in-house system of the service provider company. The service provider may get support from an outside third party to carry out the tasks corresponding to the required technical advancement. In an embodiment, the ticketing information may be categorized as effort/utilization information. Such information corresponding to ticket, for the project, may be provided to the customer. The customer may analyze the information provided by the system to estimate the project cost.

The system 300 may further include a validation block 310 (such as the data validating module 210, as explained earlier in conjunction with FIG. 2) to validate the uploaded the information corresponding to the project (hereinafter referred to as ‘project information’). The validation block 310 may receive the project information from the consuming block 305 to validate the information. In an embodiment, the project information is stored in one or more interface tables and the validation block 310 may receive the stored information therefrom.

The information may be validated based on a set of pre-defined rules to minimize errors therefrom. The validated information (hereinafter referred to as ‘validated data’) may be stored in a database such as the database 240 (as explained in description of FIG. 2). The validated data may further be provided to an aggregation module such as the aggregation module 220. The aggregation module may aggregate the data into one or more fact/summary tables to store facts and summaries corresponding to the project. The aggregated data may then be stored into the database 240 (hereinafter referred to as ‘the database’).

In an embodiment, the data may be processed (not shown) further to transform the data into more suitable form for report generation. Processing of the data has been described already by the ‘processing module 215’ in conjunction with FIG. 2), thus is not described here again, for the sake of brevity.

Further, the aggregated data may be read (from the database) by a Web-Service layer 315. The web service layer 315 may provide an online application corresponding to functioning of the system 300. The Web-Service layer 315 may be deployed on a cloud (as explained in conjunction with FIG. 1), and may be executed on a remote server to analyze various necessary attributes of the aggregated data for report generation. The analysis of the aggregated data may be utilized for report generation.

Further, the generated report may be provided to an output block 320 to provide status metrics of the project to the customer. The customer may be a user of Native Applications, Web Applications or other Business Intelligence Systems. The user of Native Application may receive report(s) on Mobile Personal Devices such as IPAD/IPhone/Blackberry etc. The user of Web Applications may view the report(s) online. In one embodiment, the user of Web Applications may view the reports by login to the system 300. In another embodiment, the user of Web Applications may receive the reports via e-mails. In an embodiment, the Business Intelligence System may leverage the aggregated facts to provide the required report(s), corresponding to the project, to the user (customer). In yet another embodiment, the user can launch a native application that resides on the mobile device that may be connectted to the web-services and receives information. In this embodiment, the user can also view all of the metrics in a disconnected mode i.e. when the user is not connected to Internet.

Also, the system 300 may enable the customers (End-users) to view reports in an offline mode. For example, the reports, with the last synced information, may be viewed by the customers even when they are not connected to network such as Internet.

Further, the system 300 includes a notification module, such as the notification module 235 (as described in conjunction with FIG. 2). In an embodiment, the notification module may provide notification to the customer, corresponding to the report generation. For example, a customer may be notified about the report generation through a Short Messaging Service (SMS) over personal mobile devices.

FIG. 4 is a flowchart illustrating a method 400 for providing status metrics of a project to a user, in accordance with an embodiment of the disclosure. Here, the user is a customer that provides the project to a service provider. The method 400 includes various steps that may be implemented by a system, such as the system 200 and the system 300 (as explained earlier with reference to FIG. 2 and FIG. 3). The method may be understood more clearly when read in conjunction with description of FIG. 2 and FIG. 3. The order and number of steps in which the method 400 is described is not intended to be construed as a limitation.

At step 405, an input data may be received from the service provider. The input data may correspond to the project. The input data may include project information such as operational information and other information corresponding to the project. The operation information may include, but is not limited to, project update, ticket information, quality information, effort utilization, resource utilization, risks involved, project iteration, action items, and time estimation. The other information may include, but is not limited to, cost and revenue information such as invoices for the project. The project updates may be provided by internal team of the service provider (company) that deals with the project. The project update may include one or more reports corresponding to the project. In an embodiment, the project update may be provided, to the customer, on weekly basis.

The ticket information my include information corresponding to support interventions that is made by technical support staff or third parties on behalf of a project handler. The project handler may include an individual or a team/group who deals with the project as, or on behalf of, the service provider. The support intervention may include additional effort that is required to perform one or more tasks corresponding to the project. For example, support may be required in case of any issue such as risk(s) or an emergency corresponding to the project. In such cases, a ticket may be raised to track the issue corresponding to the project.

Further, each customer may define a Service Level Agreement (SLA) with the service provider to make a common understanding of the service corresponding to the project. The agreement may include various terms, responsibilities, guarantees and the like corresponding to the project. In one aspect, the quality of the project, provided by the service provider, may be determined by a level of adherence to such agreement. For example, if the service agreement defines a term for providing the first interim of the project and the required interim is provided to the customer within the defined term then it may be considered as quality work corresponding to the project. Such quality information may be provided by the service provider if demand is raised by the customer.

Further, the information corresponding to effort and resource utilization may provide information about strength of a team that is working on the project and various additional resources that are required to complete the project. The project information may enable the customer to estimate the cost of the project. The input data received from the service provider may be stored in a database.

At step 410, the input data may be validated based on one or more pre-defined rules. The input data may be validated to ensure that the input data has minimal or no error. Further, in an embodiment, the validated data may be further processed by performing one or more operations to transform the data into a suitable format. The processed data may be stored in the database. The validating of the input data and processing of the validated data are explained in conjunction with FIG. 2 and FIG. 3 and thus are not repeated here for the sake of brevity.

At step 415, the validated data may be aggregated in one or more tables. The one or more tables may include, but are not restricted to, various facts and summary related to the project. In an embodiment, if the validated data is processed, the processed data may be aggregated in one or more tables of facts and summary corresponding to the project. Further, the aggregated data may be stored in the database.

At step 420, the aggregated data may be utilized to generate one or more reports corresponding to status of the project. The one or more reports may be generated by analyzing the aggregated data from one or more tables of the database. The generated reports may correspond to various areas of the project such as project update, risk involved, resource utilization, ticketing and the like. Further, the report generation may be understood more clearly when read in conjunction with the description of FIG. 2 and FIG. 3.

At step 425, the one or more reports may be provided to the customer (user) to provide a status metrics of the project. In an embodiment, the reports may be displayed to the customer on a system, such as system 200 and the system 300 as explained earlier in this disclosure. Further, the reports may be provided to the customer through various ways depending upon a type of customer. The type of the customer may include, but is not restricted to, Web Customer, Native Customer and Business Intelligence (BI) Customer (hereinafter referred to as ‘BI customer’).

The Web Customer may include the customer that utilizes Web Architecture such as Internet or cloud architecture for viewing the reports. Further, the Native Customer may include a customer that may utilize a local computer or Mobile Personal Devices to receive the status of the project. Furthermore, the BI customer may utilize a business intelligence system for viewing the project status. For example, if the customer is a Web Customer then the reports may be displayed online to the customer. Further, if the user is a Native Customer, then the reports may be provided to the user on the Mobile Personal Device such as mobile phone.

Further, the Web Customer may also receive the project status information (project status metrics) in an offline mode that is in case the user is not utilizing the Internet. In such cases, the user may be provided with the last synced information corresponding to the project. Further, in an embodiment, the customer (user) may be notified about the reports corresponding to the status metrics of the project. In an embodiment, such notifications may be provided to the customer when the report is provided to the customer for viewing. For example, the customer may receive a notification message, corresponding to generated reports, over a Mobile Phone.

The method 400 is not limited to the steps as described herein the disclosure. Various other embodiments may be included without departing from the scope of the invention.

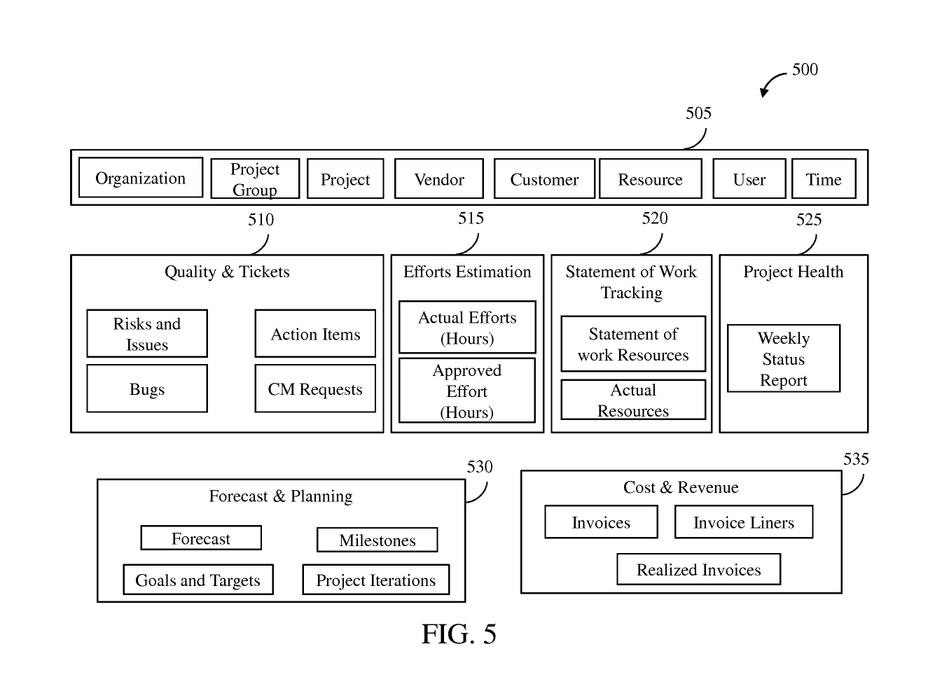

FIG. 5 is an exemplary data model 500, in accordance with one embodiment of the disclosure. FIG. 5 is explained in conjunction with description of FIG. 2, FIG. 3 and FIG. 4. The data model 500 may include structures of various tables that may be used to build a database. Each table may include information corresponding to a project received, by a service provider, from a customer. The tables may store an input data, a validated data, a processed data, and an aggregated data corresponding to various modules as explained in FIG. 2. Further, the data from the database may be utilized to generate one or more reports corresponding to the project.

The database is generated by a system, such as the system 200 and the system 300, to process the input data. The system may be utilized by various service providers and customers. The service providers may include, but is not restricted to, an organization such as a consulting company, a functional unit (group), and the like. The customers may include an organization or an individual user. The system may utilize various data modeling technique to build the database.

The database may include various tables containing information corresponding to various business elements such as an organization, project group that deals directly with a project, the project, a vendor, a customer (for providing the project to the service provider), a resource, a user and the like. Accordingly, FIG. 5 represents a section 505 that is organized for different business elements. In an embodiment, the database may include various tables corresponding to each business elements. In an embodiment, the customers (clients) may provide information related to multiple vendors. For example, if a project is assigned to multiple vendors and each vendor does separate activities on the project, data can be received from each vendor and uploaded to the system. The system may collate all the data and represent information corresponding to the project in the table for ‘project’ entity. Similarly, the data received from each vendor may be represented in tables corresponding to each vendor separately.

The data model 500 includes various tables and various related objects corresponding to each table. The data model 500 may include, but is not limited to, various tables such as table for ‘quality and tickets’ 510, ‘effort estimation’ 515, a ‘statement of work tracking’ 520, a ‘project health’ 525, ‘forecast and planning’ 530, ‘cost and revenue’ 535. Each table may include corresponding information (related objects) such as the table for the ‘quality and tickets’ 510 may include, but is not restricted to, ‘risks and issues’, ‘action items’, ‘bugs’ and ‘CM requests’ corresponding to the project. As explained earlier in conjunction with FIG. 2, FIG. 3 and FIG. 4, a ticket may be raised in case of any ‘risks and issues’ and quality of the project may be determined through various action items taken in case of bugs. The ‘quality and tickets’ 510 may be understood when read in conjunction with previous explanation in this disclosure.

Similarly, ‘effort estimation’ 515 may store the information that may enable the customer to determine the effort consumption for the project. For example, the information corresponding to ‘effort estimation’ 515 includes ‘actual effort hours’ and ‘approved effort hours’. The ‘statement of work tracking’ 520 (hereinafter referred to as ‘SOW Tracking 520’) may define project related activities, deliverables and timeline that corresponding to the project. For example, ‘SOW tracking’ 520 may include, but is not limited to, ‘SOW resources’ and ‘actual resources’ (as shown).

Further, the ‘project health’ 525 includes information corresponding to status of the project. Thus, the table for ‘project health’ 525 may include ‘weekly status report’ to provide weekly reports to the customer. Also, the ‘forecast and planning’ 530 includes various predicted information corresponding to the project. For example, information corresponding to the ‘forecast and planning’ 530 may include, but is not limited to, ‘forecast’, ‘milestones’, ‘goals and targets’ and ‘project iterations’ (as shown).

The ‘cost and revenue’ 535 may include other information (not operational information, as explained in conjunction with FIG. 2 and FIG. 3) corresponding to the project. The ‘cost and revenue’ 535 may include, but is not limited to, invoices, invoice liners and realized invoices corresponding to the project.

The information (as described above) may be utilized by the system to generate one or more reports. Further, it may be appreciated by any person skilled in the art that the business elements, tables, and the information corresponding to each table is not limited to the explanation of FIG. 5. Further, various more tables may be included for providing additional information corresponding to the status of the project.

The present disclosure as described above has numerous advantages. The project status, provided to the customer, may enable the customer to get insight of the performance and status metrics of the project. Further, through the project status metrics, the customer may analyze adherence between the customer and the service provider based on SLA (Service Level Agreement). As described earlier in this disclosure, the SLA may be defined by the customer and the service provider to specify target performance, operation or other attributes of the service, such as billing, corresponding to the project.

Further, the customer may maintain historical information, such as weekly progress, of the project, ticket closure trends and the like. This may enable the customer to estimate cost of the project. Furthermore, the customer may login, anytime, to the system (as explained earlier in conjunction with FIG. 2 and FIG. 3), to view real-time information corresponding to the project status metrics. Thus, in this case, the customer is not required to wait for a weekly report to know the status of the project. Also, the customers may receive the project status metrics on personal mobile devices such as IPAD, IPhone, Blackberry etc. The system may further enable the customer to analyze the data in an offline mode on personal mobile devices.

Thus, the system may provide ease for the customer in receiving the project status metrics in minimal time. Further, the system may provide an easy way to the service provider in providing the project status metrics without requiring manual preparation of reports for the project.

Also, the project status metrics may provide information corresponding to project schedule, effort variance and resource utilization for the project. Such project metrics may provide heuristics for future planning.

The invention is not limited to the advantages as mentioned above, in the disclosure. Further, the invention is not limited to the embodiments as mentioned above in this disclosure. Accordingly, the Detailed Description and corresponding figures are to be regarded as illustrative examples of the present disclosure, rather than in restrictive sense. All such possible modifications are intended to be included within the scope of the present disclosure.

The present invention may also be embodied in a computer program product for providing a status metrics of a project to a user. The computer program product may include a non-transitory computer usable medium having a set program instructions comprising a program code for enabling the user to view the status metrics of the project. The set of instructions may include various commands that instruct the processing machine to perform specific tasks such as providing various reports corresponding to the project to the user to provide the status information corresponding to the project. The set of instructions may be in the form of a software program. Further, the software may be in the form of a collection of separate programs, a program module with a large program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limit to these embodiments only. Numerous modifications, changes, variations, substitutions and equivalents will be apparent to those skilled in the art without departing from the spirit and scope of the invention, as described in the claims.

The foregoing description sets forth numerous specific details to convey a thorough understanding of embodiments of the invention. However, it will be apparent to one skilled in the art that embodiments of the invention may be practiced without these specific details. Some well-known features are not described in detail in order to avoid obscuring the invention. Other variations and embodiments are possible in light of above teachings, and it is thus intended that the scope of invention not be limited by this Detailed Description, but only by the following Claims.

What is claimed is:

1. A method for providing status metrics of a project to a user, the method comprising:
receiving an input data corresponding to the project;
validating the input data based on one or more pre-defined rules;
aggregating the validated data into one or more tables;
generating one or more reports by analyzing one or more attributes of the aggregated data from the one or more tables, the generated report comprising project information corresponding to the project; and
providing the generated one or more reports to the user, thereby providing the status metrics of the project to the user.

2. The method of claim 1, wherein the input data is received from a service provider.

3. The method of claim 1 further comprising:
processing the validated data by performing one or more operations on the validated data; and
aggregating the processed data into the one or more tables.

4. The method of claim 1 further comprising providing a notification to the user, the notification corresponding to the generated report.

5. The method of claim 1, wherein the input data comprises at least one of ticket information, quality information, project update and effort information corresponding to the project.

6. The method of claim 1, wherein the project information comprises at least one of project update, resource information, effort estimation, and Quality information corresponding to the project.

7. The method of claim 1, wherein the one or more tables comprise at least one of one or more facts tables and one or more summary tables corresponding to the project.

8. The method of claim 1 further comprising providing a flexibility to the user to view at least one of the data from the one or more tables and the one or more generated reports.

9. An online system for providing a status metrics of a project to a user, the system comprising:
a data consuming module for receiving an input data corresponding to the project;
a data validating module configured for validating the input data based on one or more pre-defined rules;
an aggregation module for aggregating the validated data into one or more tables;
a report generation module configured to generate one or more reports by analyzing one or more attributes of the aggregated data from the one or more tables, the generated report comprising project information corresponding to the project; and
a status providing module configured to provide the generated one or more reports to the user, thereby providing the status metrics of the project to the user.

10. The system of claim 9, wherein the data consuming module receives the input data from a service provider.

11. The system of claim 9 further comprising a processing module for processing the validated data by performing one or more operations on the validated data, the processed data aggregated into the one or more tables.

12. The system of claim 9 further comprising a notification module to provide notification to the user, the notification corresponding to the generated report.

13. The system of claim 9, wherein the project information comprises at least one of project update, resource information, effort estimation, and quality information corresponding to the project.

14. The system of claim 9, wherein the one or more tables comprise at least one of one or more facts tables and one or more summary tables corresponding to the project.

15. The system of claim 9, wherein the status providing module further configured to provide flexibility to the user to view at least one of the data from the one or more tables and the one or more generated reports.

16. The system of claim 9 further comprising a database for storing the one or more tables therein.

17. The system of claim 9 further comprising a receiving module for receiving a request from the user, the request corresponding to the status metrics for the project.

18. The system of claim 17, wherein the status providing module is further configured to provide information from the aggregated data to the user, the aggregated data being provided based on the request received from the user.

19. A computer program product for use with a computer, the computer program product comprising a non-transitory computer usable medium having a computer readable program code embodied therein for providing a status metrics of a project to a user, the computer readable program code when executed performing a method comprising:
receiving an input data corresponding to the project;
validating the input data based on one or more pre-defined rules;
aggregating the validated data into one or more tables;
generating one or more reports by analyzing one or more attributes of the aggregated data from the one or more tables, the generated report comprising project information corresponding to the project; and
providing the generated one or more reports to the user, thereby providing the status metrics of the project to the user.

20. The computer program product of claim 19, wherein the computer program code receives the input data from a service provider.

21. The computer program product of claim 19, wherein the computer program code further performs:
processing the validated data by performing one or more operations on the validated data; and
aggregating the processed data into the one or more tables.

22. The computer program product of claim 19, wherein the computer program code further performs providing notification to the user corresponding to the generated report.

23. The computer program product of claim 19, wherein the input data comprises at least one of ticket information, quality information, project update and effort information corresponding to the project.

24. The computer program product of claim 19, wherein the project information comprises at least one of project update, resource information, effort estimation, and Quality information corresponding to the project.

25. The computer program product of claim 19, wherein the one or more tables comprise at least one of one or more facts tables and one or more summary tables corresponding to the project.

26. The computer program product of claim 19 wherein the computer program code further performs providing flexibility to the user to view at least one of the data from the one or more tables and the one or more generated reports.
